(19) United States
(12) Patent Application Publication
(10) Pub. No.: US 2010/0229387 A1
(43) Pub. Date: Sep. 16, 2010

(54) MULTI-MATERIAL TURBINE ENGINE SHAFT

(75) Inventor: Ioan Sasu, Brossard (CA)

Correspondence Address: OGILVY RENAULT LLP (PWC), 1, PLACE VILLE MARIE, SUITE 2500, MONTREAL, QC, H3B 1R1, CA

(73) Assignee: Pratt & Whitney Canada Corp, Longueuil (CA)

(21) Appl. No.: 12/359,618

(22) Filed: Jan. 26, 2009

Related U.S. Application Data
(62) Division of application No. 11/181,870, filed on Jul. 15, 2005, now abandoned.

(51) Int. Cl. B23P 15/04

(52) U.S. Cl. 29/889.2

(57) ABSTRACT

A turbine engine shaft comprising an end section thereof made of high temperature resistant super-alloy adapted for working in a hot section of the engine, and a remaining section of the shaft made of steel. The end section and the remaining section are directly joined together to form a single-piece shaft.

### CROSS-REFERENCE TO RELATED APPLICATIONS

This is a Divisional of Applicant's U.S. patent application Ser. No. 11/181,870, filed on Jul. 15, 2005.

### TECHNICAL FIELD

The invention relates generally to gas turbine engines, and more particularly to multi-material rotor shafts of gas turbine engines.

### BACKGROUND OF THE ART

An aircraft gas turbine engine typically includes one or more drive or rotor shafts for transferring torque from one rotating component to another, for example, linking together the turbine to the fan or propeller, etc., depending on the type of engine. The shaft extends axially across the engine, from a cold section which accommodates a fan and compressor to a hot section which accommodates the turbine. Efforts to increase engine performance have resulted in higher engine temperatures, and thus the shaft temperature in the turbine section has increased accordingly to an elevated level, for example, up to 950° F. Engine shafts must therefore be formed of suitable high temperature, high strength materials for carrying loads at elevated temperatures during operation. For example, high temperature resistant super-alloys such as nickel alloys are conventionally required for the entire shaft. This however makes the shaft very expensive and heavy due to the poor machine-ability and high density of the nickel alloys. Therefore, composite shafts have been suggested such as in U.S. Pat. No. 6,749,518, in which a shaft has both ends of Ni alloy and a mid section made of a Metal Matrix Composite (MMC) material. Two transition pieces are used to prevent the formation of inter-metallic compounds between the different materials when an MMC material is joined with a Ni alloy in a friction welding process.

Nevertheless, there is still a need for improved multi-material turbine engine shafts and methods of making same.

### SUMMARY OF THE INVENTION

It is therefore an object of this invention to provide a multi-material turbine engine shaft and a method of making same.

In one aspect, the present invention provides a turbine engine shaft which comprises an end section thereof made of a high temperature resistant super-alloy adapted for working in a hot section of a turbine engine, and a remaining section of the shaft made of steel. The end section and the remaining section are directly joined together to form a single-piece shaft.

In another aspect, the present invention provides a method for manufacturing a gas turbine engine shaft. The method comprises: (a) preparing at least a first section of the shaft made of a high temperature resistant super-alloy and a second section of the shaft made of steel; (b) joining the first and second sections end to end by a welding process; (c) conducting a heat treatment of the super-alloy and a treatment of the steel to the respective first and second sections which are joined together; and (d) machining the joined first and second sections.

Further details of these and other aspects of the present invention will be apparent from the detailed description and figures included below.

### DESCRIPTION OF THE DRAWINGS

Reference is now made to the accompanying drawings depicting aspects of the present invention, in which:

FIG. 1 is schematic cross-sectional view of an exemplary turbofan gas turbine engine, showing an application of the present invention; and

FIG. 2 is partial cross-sectional view of a multi-material engine shaft according to one embodiment of the present invention.

### DETAILED DESCRIPTION OF THE PREFERRED EMBODIMENTS

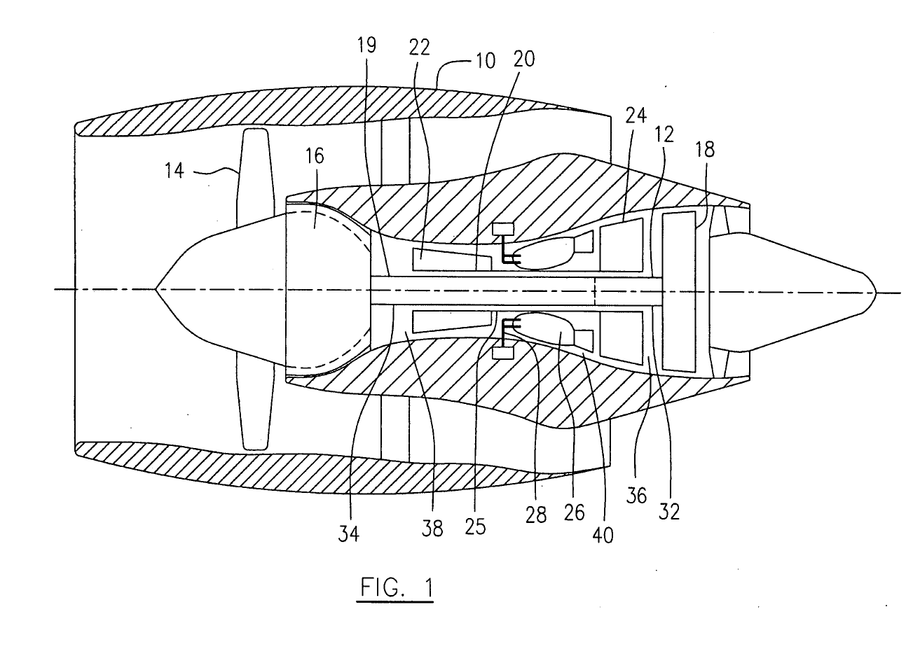

A typical application of the present invention for a turbofan engine illustrated schematically in FIG. 1, incorporates an embodiment of the present invention presented as an example of the application of the present invention. The turbofan engine includes a housing or nacelle 10, a low pressure spool assembly seen generally at 12 which includes a fan 14, low pressure compressor 16 and low pressure turbine 18 connected by shaft 19, a high pressure spool assembly seen generally at 20 which includes a high pressure compressor 22 and a high pressure turbine 24 connected by shaft 25. There is provided an annular combustor 26 and a plurality of fuel injectors 28 in order to produce hot combustion gases to power the turbines 24 and 18. Application of the invention is not restricted to turbofans, however this turbofan engine is selected for convenience of description of the present invention.

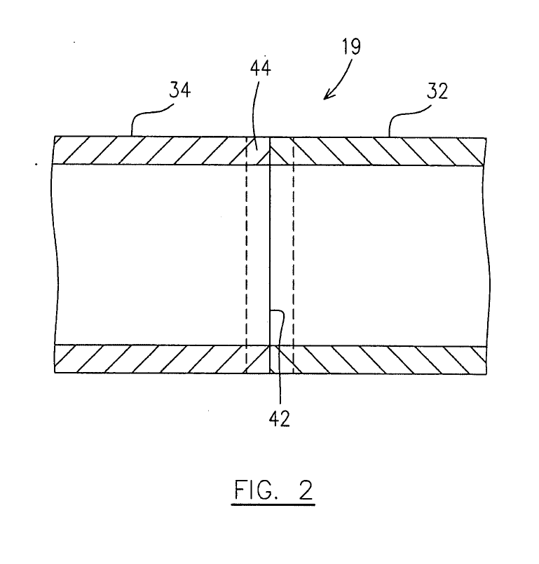

Referring to FIGS. 1 and 2, shaft 19, as an example of the present invention, is a multi-material shaft and includes for example, a first section, such as an end section 32 thereof, and a second section, such as the remaining section 34 thereof, which are made of different materials and prepared separately. The end section 32 on which a turbine disc such as the low pressure turbine 18 is mounted, is adapted for working in a hot section 36 of the engine where hot gases discharged from the combustor 26 raise the shaft temperature at the end section 32 to an elevated level, for example up to 950° F. In order to resist this high temperature, a high temperature resistant super-alloy material, preferably nickel alloys (Ni alloys), such as Alloy 718, for example as available from one source under the name Inconell®, are required for the end section 32 of shaft 19. The remaining section 34 of shaft 19 extends through a cold section 38 of the engine where the fan 14 and compressors 16, 22 are located, and through an intermediate section 40 where the annular combustor 26 is located. The shaft temperature of the remaining section 34 of shaft 19 is significantly lower than the shaft temperature of end section 32 and therefore steel can be used as the material for this remaining section 34 of shaft 19, thereby reducing the manufacturing cost of shaft 19 and possibly further reducing the weight thereof, depending on the particular type of steel selected.

The end section 32 and the remaining section 34 of shaft 19 are joined together end to end, preferably by a friction welding process which is known in the prior art and will not be described in detail. Another possible technique as an alternative to the friction welding process, is explosion welding which is also known in the art and will not be described in detail. Nevertheless, the formation of inter-metallic compounds at the interfaces between dissimilar metal materials will usually result in brittleness and unpredictability in the joint properties and therefore a layered transition piece which incorporates a barrier material such as a niobium alloy is conventionally used between the two materials being welded together in order to prevent the formation of inter-metallic compounds.

In contrast to the conventional technology of using layered transition pieces in a welding process, according to the present invention, the end section 32 is directly welded to the remaining section 34 without a transitional piece positioned therebetween. In this embodiment, improved properties of a welding zone 44 which is located at the interface 42 of the sections 32, 34 and symbolically defined by broken lines (not indicated), are achieved by an appropriate heat treatment process conducted after the end section 32 and the remaining section 34 of the shaft 19 are welded together, in contrast to the prior art heat treatment of the separate sections before being welded. Therefore, it is preferable to select the steel used for the remaining section 34 of shaft 19 from those having properties allowing a heat treatment of steel which is compatible with the heat treatment of the super alloy used for the end section 32 of shaft 19, in order to obtain a desired structure in the welding zone 44 between the joined sections 32, 34. For example, the steel used for the remaining section 34 of shaft 19 can be selected from HCM3 which makes it possible to reduce the total weight and the manufacturing cost of shaft 19. Another alternative selection, AMS6414 is also preferably used for the remaining section 34 of shaft 19.

The above description is meant to be exemplary only, and one skilled in the art will recognize that changes may be made to the embodiments described without departure from the scope of the invention disclosed. For example, the method of manufacturing a gas turbine shaft of the present invention is fully applicable to the manufacturing of shaft 25 of the high pressure spool assembly 20, as well as rotor shafts in other engine types. The method for manufacturing a gas turbine engine shaft of the present invention is also applicable to any type of multi-material turbine engine shaft which includes jointed sections made of respective high temperature resistant super-alloys and steel. Still other modifications which fall within the scope of the present invention will be apparent to those skilled in the art, in light of a review of this disclosure, and such modifications are intended to fall within the appended claims.

1. A method for manufacturing a gas turbine engine shaft comprising:
(a) preparing at least a first section of the shaft made of a high temperature resistant super-alloy and a second section of the shaft made of steel;
(b) placing the first and second sections in an end-to-end contact with one another and then joining said sections by a welding process conducted between said ends;
(c) heat treating the first and second sections after the welding process; and
(d) machining the joined first and second sections.

2. The method as claimed in claim 1 wherein the welding process in step (b) is conducted directly between the first section and the second section.

3. The method as claimed in claim 2 wherein the welding process in step (b) is practiced in a friction welding process.

4. The method as claimed in claim 1 wherein the welding process in step (b) is practiced in an explosion welding process.

5. The method as claimed in claim 1 wherein in step (a) the steel used for the second section of the shaft is selected to have properties to allow the heat treatment of steel compatible with the heat treatment of the super-alloy used for the first section, in order to obtain a desired structure in a welding zone between the joined first and second sections.

6. The method as claimed in claim 5 wherein in step (a) AMS6414 is selected for the second section of shaft.

7. The method as claimed in claim 5 wherein in step (a) HCM3 is selected for the second section of shaft.

8. The method as claimed in claim 1 wherein in step (a) a Ni alloy is selected for the first section of the shaft.

9. The method as claimed in claim 1 wherein in step (a) Inconel 718 is selected for the first section of the shaft.

10. The method as claimed in claim 1 wherein a single heat treatment is applied to both the first and second sections after the welding process.

11. The method as claimed in claim 1 wherein the first and second sections are comprised entirely of said super-alloy and said steel, respectively, and wherein the joint is free from any layered transition piece between the sections
